(19) United States
(12) Patent Application Publication
(10) Pub. No.: US 2025/0317600 A1
(43) Pub. Date: Oct. 9, 2025

(54) METHOD FOR JOINT SPATIAL-TEMPORAL MESH DECIMATION

(71) Applicant: TENCENT AMERICA LLC, Palo Alto, CA (US)

(72) Inventors: Pranav Aniruddha KADAM, Los Angeles, CA (US); Shan LIU, San Jose, CA (US); Wei DING, Palo Alto, CA (US)

(21) Appl. No.: 19/059,503

(22) Filed: Feb. 21, 2025

Related U.S. Application Data
(60) Provisional application No. 63/574,205, filed on Apr. 3, 2024.

(51) Int. Cl. H04N 19/597; G06T 17/20; H04N 19/147

(52) U.S. Cl. CPC H04N 19/597; G06T 17/205; H04N 19/147

(57) ABSTRACT

A method performed by at least one processor in an encoder includes receiving a plurality of frames, each frame including a polygon mesh; selecting one frame from the plurality of frames; performing decimation on the polygon mesh of the one frame to generate a decimated mesh; and encoding, using the decimated mesh, the polygon mesh in at least one frame from the plurality frames excluding the one frame.

### CROSS-REFERENCE TO RELATED APPLICATION

This application claims priority from U.S. Provisional Application No. 63/574,205 filed on Apr. 3, 2024, the disclosure of which is incorporated herein by reference in its entirety.

### FIELD

This disclosure is directed to a set of advanced video coding technologies. More specifically, the present disclosure is directed to joint spatial-temporal mesh decimation.

### BACKGROUND

The advances in 3D capture, modeling, and rendering have promoted the ubiquitous presence of 3D contents across several platforms and devices. Nowadays, it is possible to capture a baby's first step in one continent and allow the grandparents to see (and maybe interact) and enjoy a full immersive experience with the child in another continent. Nevertheless, in order to achieve such realism, models are becoming ever more sophisticated, and a significant amount of data is linked to the creation and consumption of those models. 3D meshes are widely used to represent such immersive contents.

A mesh is composed of several polygons that describe the surface of a volumetric object. Each polygon is defined by its vertices in 3D space and the information of how the vertices are connected, referred to as connectivity information. Optionally, vertex attributes, such as colors, normals, etc., could be associated with the mesh vertices. Attributes could also be associated with the surface of the mesh by exploiting mapping information that parameterizes the mesh with 2D attribute maps. Such mapping is usually described by a set of parametric coordinates, referred to as UV coordinates or texture coordinates, associated with the mesh vertices. 2D attribute maps are used to store high resolution attribute information such as texture, normals, displacements etc. Such information could be used for various purposes such as texture mapping and shading.

A dynamic mesh sequence may require a large amount of data since it may consist of a significant amount of information changing over time. Therefore, efficient compression technologies are required to store and transmit such contents. Mesh compression standards IC, MESHGRID, FAMC were previously developed by MPEG to address dynamic meshes with constant connectivity and time varying geometry and vertex attributes. However, these standards do not take into account time varying attribute maps and connectivity information. DCC (Digital Content Creation) tools usually generate such dynamic meshes. In counterpart, it is challenging for volumetric acquisition techniques to generate a constant connectivity dynamic mesh, especially under real time constraints. This type of contents is not supported by the existing standards. MPEG is planning to develop a new mesh compression standard to directly handle dynamic meshes with time varying connectivity information and optionally time varying attribute maps. This standard targets lossy, and lossless compression for various applications, such as real-time communications, storage, free viewpoint video, AR and VR. Functionalities such as random access and scalable/progressive coding are also considered.

The UV Atlas tool is presently used to obtain the UV parameterization of the decimated mesh. It is observed that while the decimated meshes from consecutive frames closely resemble each other due to very small motion between them, the corresponding UV charts are not temporally correlated. This leads to poor texture compression due to limited inter-prediction between successive frames.

### SUMMARY

According to an aspect of the disclosure, a method performed by at least one processor in an encoder, the method includes: receiving a plurality of consecutive mesh frames, each mesh frame including a polygon mesh; selecting one frame from the plurality of consecutive mesh frames; performing decimation on the polygon mesh of the one frame to generate a decimated mesh by reusing the plurality of consecutive mesh frames which share the same decimated mesh; and encoding, using the decimated mesh, the polygon mesh in at least one frame from the plurality frames excluding the one frame.

According to an aspect of the disclosure, A method performed by at least one processor in a decoder, the method includes: receiving a coded video bitstream comprising a plurality of consecutive mesh frames; extracting from the coded video bitstream a parameter indicating a number of a set of frames from the plurality of consecutive mesh frames that are associated with each other; decoding a decimated mesh of a first frame from the plurality of consecutive mesh frames that share the same decimated mesh; and decoding a second frame from the set of frames using the decimated mesh of the first frame.

According to an aspect of the disclosure, a method performed by at least one processor in an encoder includes: processing a plurality of consecutive mesh frames, each mesh frame including a polygon mesh; in which one frame from the plurality of consecutive mesh frames is selected, in which decimation is performed on the polygon mesh of the one frame to generate a decimated mesh by reusing the plurality of consecutive mesh frames which share the same decimated mesh, and in which the polygon mesh in at least one frame from the plurality frames excluding the one frame is encoded using the decimated mesh.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is an illustration of a VMesh geometry encoder, in accordance with embodiments of the present disclosure.

FIGS. 4A and 4B illustrate results of atlas parameterization of consecutive frames of an input mesh, in accordance with embodiments of the present disclosure.

FIGS. 5A and 5B illustrate results of atlas parameterization of consecutive frames of a decimated mesh, in accordance with embodiments of the present disclosure.

FIG. 6 illustrates a flowchart of a process for performing joint spatial-temporal mesh decimation.

FIG. 7 is a diagram of a computer system suitable for implementing the embodiments of the present disclosure, in accordance with embodiment of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

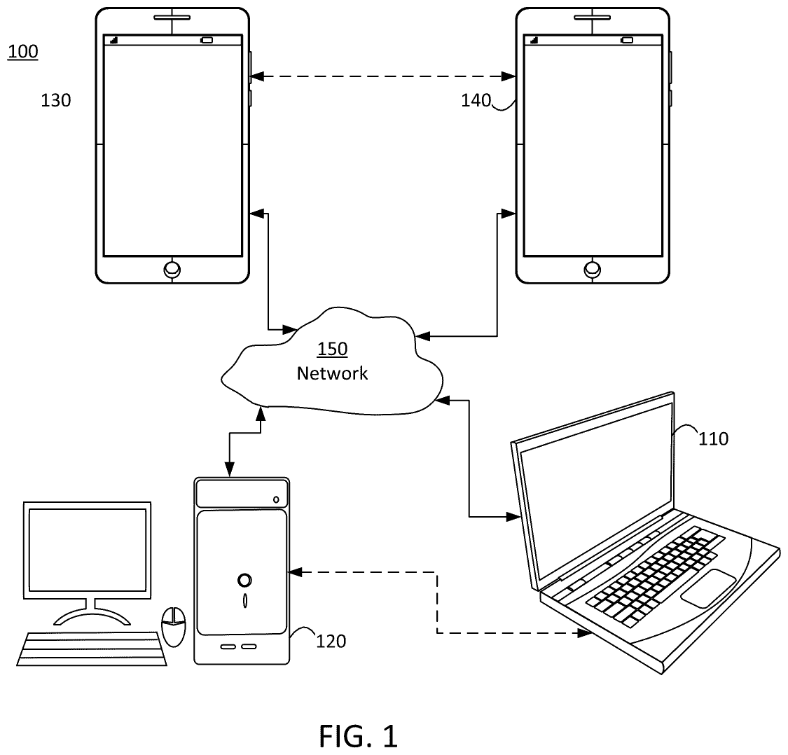

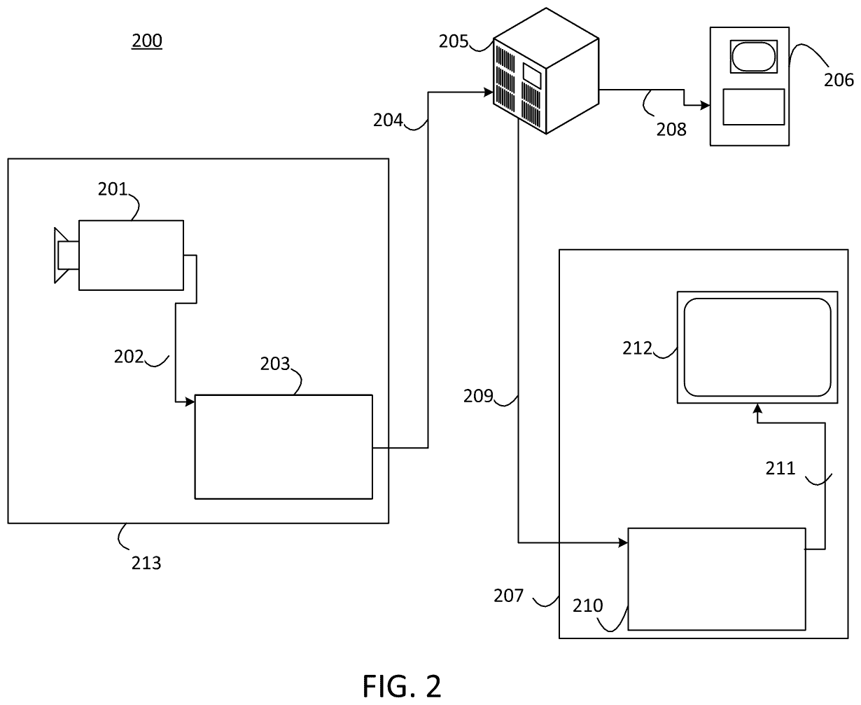

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

Embodiments of the present disclosure are directed to processing of a Group of Decimated Frames (GoDF), which is a sequence of meshes that share a similar decimated mesh (e.g., mesh with same connectivity and same/different vertex positions). The decimated mesh for the GoDF may be derived from input meshes within the GoDF using joint spatial-temporal optimization.

In one or more examples, a mesh coding pipeline involves geometry and texture coding. The geometry coder encodes the mesh connectivity, vertex positions, UV coordinates and other information such as normal coordinates, if available. For texture coding, a video encoder is used. Before encoding, the mesh may be preprocessed to reduce complexity and/or to meet bandwidth needs. Preprocessing can include operations like mesh decimation, subdivision and re-meshing on the mesh geometry and texture resolution modification.

According to one or more embodiments, the attributes of a mesh include a vertex position, a texture coordinate, a normal vector, an associated texture map. For geometric attribute like vertex position, predictive coding scheme is often employed, for example, with parallelogram prediction. In terms of polygonal mesh, parallelogram prediction may perform the best with a quadrilateral mesh.

Mesh simplification is often performed to simplify the representation of the mesh, thus reduce the encoding information for compression. Simplification could be done via decimation or remeshing. Decimation could be done via edge collapsing or face merging. However, decimation only aims to approximate the shape of the original mesh without concerning the regularity of face degree and vertex valance. On the other hand, previous remeshing method are struck on regularize the face and vertex degree, but failed to maintain the approximation quality the mesh at a reasonable number of attributes.

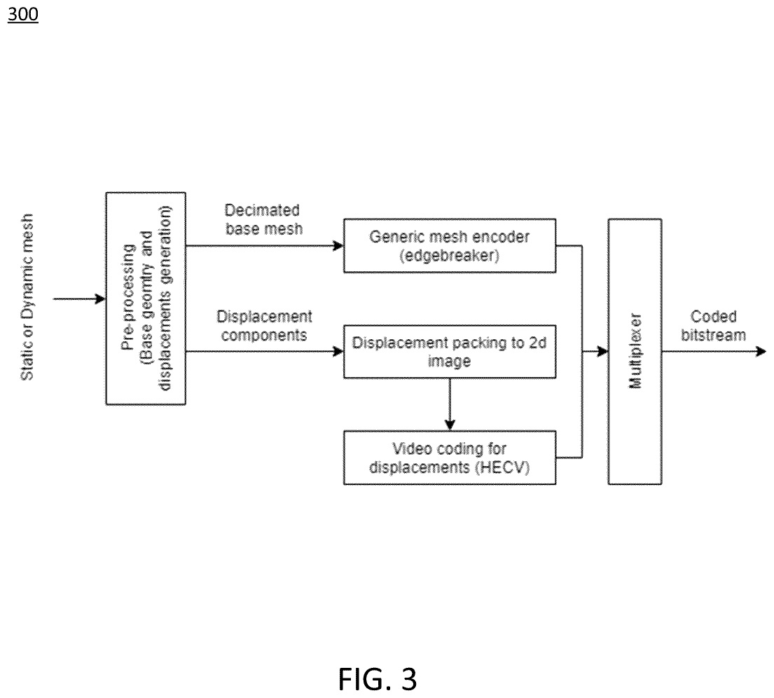

MPEG VMesh and AOMedia VVM are two mesh coding standards that process meshes. The VMesh reference software compresses meshes based on decimated meshes (e.g., encoded by open source Draco), displacements vectors and motion fields (if applicable). To encode the displacement, displacement vectors are transformed into wavelet coefficients by the linear lifting scheme, and then the coefficients are quantized and coded by a video codec or arithmetic codec. Texture transfer is performed to match the texture with re-parameterized geometry and UV as well as to optimize texture for image compression. An overview of geometry encoding in VMesh is illustrated in FIG. 3.

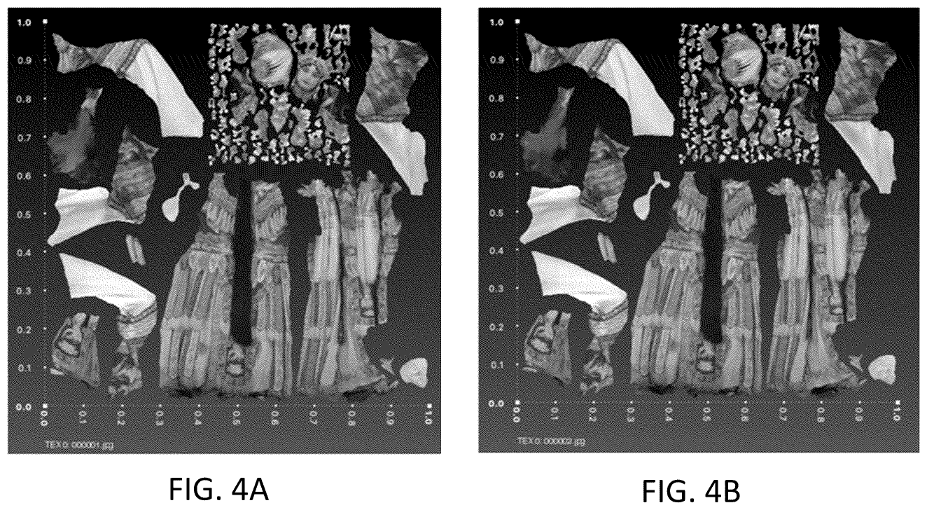

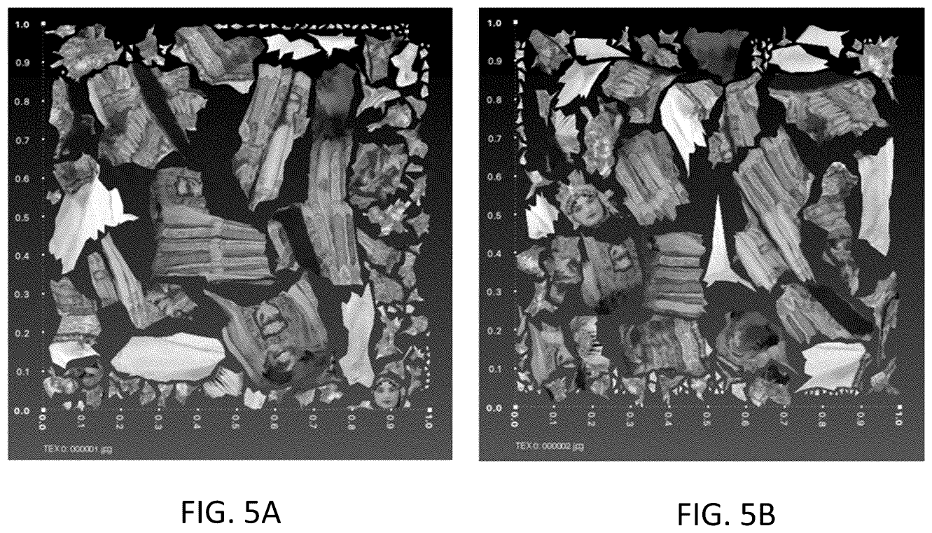

The UV Atlas tool is presently used to obtain the UV parameterization of the decimated mesh. It is observed that while the decimated meshes from consecutive frames closely resemble each other due to very small motion between them, the corresponding UV charts are not temporally correlated. This leads to poor texture compression due to limited inter-prediction between successive frames. This issue is illustrated in FIGS. 4A, 4B, 5A, and 5B. As illustrated in FIG. 4A, two consecutive frames of the input mesh have good correlation in their atlas parameterization. However, as illustrated in FIGS. 5A and 5B, after decimation the new parameterization is not suitable for texture coding. As a result, the bitrate saved in geometry due to encoding of the decimated mesh with fewer vertices is nullified by a significant increase in the texture coding bitrate.

A decimated mesh shared by a subset of consecutive frames can allow for consistency in the UV charts, and thereby, efficient video compression of texture images. These features can help mitigate the previous issue. In existing approaches, the mesh decimation is performed for each frame independently (spatially optimized decimation). However, for a decimated mesh to be shared by a subset of consecutive frames, decimation can benefit by considering both past and future frames (joint spatial-temporal decimation).

The proposed methods may be used separately or combined in any order and may be used for arbitrary polygon meshes.

According to one or more embodiments, a decimated mesh may be reused within a “decimation intra-refresh period.” In one or more examples, the decimation intra-refresh period may be defined as a number of consecutive mesh frames which share a same decimated mesh. Meshes within the decimation intra-refresh period may form the “Group of decimated frames (GoDF)”. The input mesh within the GoDF to be decimated may be determined in accordance with one or more of the following examples.

In one or more examples, the decimated mesh of each GoDF may be obtained by decimating the first mesh of the GoDF.

In one or more examples, the decimated mesh of each GoDF may be obtained by decimating the center frame of the GoDF.

In one or more examples, the decimated mesh of each GoDF may be obtained by decimating an arbitrarily selected mesh within that GoDF based on rate distortion optimization as follows.

In one or more examples, the input mesh which after decimation leads to fewest bits to encode may be selected.

In one or more examples, the input mesh which after decimation leads to the lowest distortion in terms of point-to-point distance error and/or point-to-plane distance error shall be selected. In one or more examples, a point-to-point distance error is the difference between two vertices (e.g., vertex in decimated mesh and vertex in decimated mesh). The point-to-point distance may represent a total sum of distance errors between each vertex in the decimated mesh and the corresponding vertex in the input mesh. In one or more examples, a point-to-plane distance error may refer to a perpendicular distance between a given point in space and the nearest point on a plane. For example, the point may refer to a vertex in the decimated mesh, and the nearest point on a plane may refer to a nearest vertex in input mesh.

In one or more examples, a temporal decimation cost shall be defined for each input mesh within the GoDF. The temporal decimation cost may be given by a weighted sum of encoding rate and distortion error. Then, the input mesh which gives the least temporal decimation cost may be selected to decimate. In one or more examples, the encoding rate may refer to an amount of data encoded in a unit of time, or the bit rate, and the speed at which a source is encoded (e.g., encoding speed). In one or more examples, the distortion error may refer to the amount of distortion in a decimated mesh with respect to the input mesh. In one or more examples, the encoding rate and the distortion error may be equally weighted. In one or more examples, the encoding rate may be weighted more than the distortion error. In one or more examples, the distortion error may be weighted more than the encoding rate.

In one or more examples, mesh decimation in VMesh may be conducted independently for each mesh (spatial decimation). According to one or more embodiments, the decimated mesh for the GoDF may be jointly optimized using all or subset of meshes from that GoDF (joint spatial-temporal decimation). A method for joint spatial-temporal decimation as discussed below or any equivalent method may be used.

First, an initial decimated mesh for the GoDF may be determined using an approach described above or in any other manner. Second, the mesh connectivity may be fixed, and only the vertex positions and/or the UV coordinates of this initial decimated mesh may be refined. The refined vertex position may be derived from the positions of all neighborhood vertices across all the input meshes within the GoDF. An example refinement operator may be the position average. In one or more examples, for each vertex position to be refined, all the neighborhood vertices within a radius are fetched from all the input meshes in the GoDF. The refined position may be the coordinate wise average of all the neighborhood vertex positions. Other local smoothing operators and optimization strategies may be adopted independently or jointly with this method.

According to one or more embodiments, the decimated mesh within the GoDF is tracked. Using the same decimated mesh across the GoDF may be suboptimal in scenarios such as when the decimation intra-refresh period is large and/or when the motion between two consecutive mesh frames is large. Tracking the decimated mesh may help preserve the consistency in the UV charts and at the same time keep the geometric distortion within a limit.

In one or more examples, a reference decimated mesh for the GoDF may be obtained using any of the approaches discussed above. Then, decimation may be performed on the first frame of the GoDF independently. Later, this decimated mesh of first frame may be re-meshed to have a same connectivity as that of the reference decimated mesh. The re-meshing operation may involve modifying the vertex positions of the reference mesh so as to best fit the decimated mesh. In one or more examples, re-meshing may include minimizing the point-to-point error metric and/or the point-to-plane error metric between the meshes before and after re-meshing. This re-meshed decimated output may then be used as the decimated mesh for the first frame. This process may be repeated for all the meshes in the GoDF. This approach ensures that the decimated meshes within the GoDF follow the same connectivity and have a one-to-one correspondence among the vertices.

According to one or more embodiments, the single connectivity constraint from the above embodiment may be exploited, and the different in vertex positions between consecutive decimated meshes may be encoded as residue instead of encoding each decimated mesh independently. Accordingly, the first decimated mesh of the GoDF may be encoded using the mesh encoder (connectivity and value coding of vertices and UV) similar to an intra frame. Then, for the second decimated mesh, the residue for each vertex shall be calculated as difference in position between the second and the first decimated mesh. Due to the one-to-one correspondence between vertices, this calculation is a simple vector difference. The residue may be then encoded using any displacement coding mechanism known to one of ordinary skill in the art. Similarly, the second decimated mesh may be used to find the residue for the third and so on. Concurrently, the UV connectivity and value coding may be skipped except for the first I-frame within the GoDF. The UV connectivity and values of all the meshes are set to be the same as that of the I-frame in the GoDF.

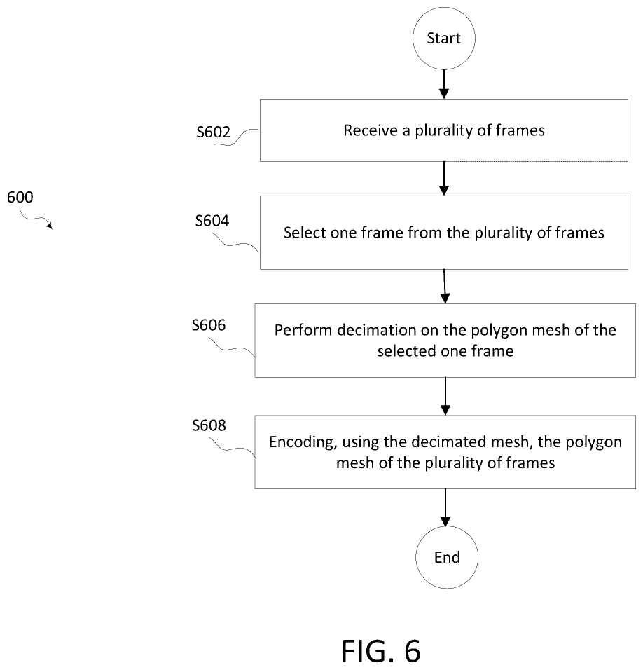

FIG. 6 illustrates a flowchart of performing an example process 600 for joint spatial-temporal mesh decimation. The process 600 may be performed by encoder 203 (FIG. 2).

The process may start at operation 602 where a plurality of consecutive mesh frames are received. The plurality of consecutive mesh frames may be consecutive frames in a video, where each frame contains a polygon mesh. The plurality of consecutive mesh frames may be frames occurring within a decimation intra-refresh period (e.g., 5 secs or 10 consecutive frames).

The process proceeds to operation 604 where one frame may be selected from the plurality of consecutive mesh frames. The selected frame may be the first frame in the plurality of consecutive mesh frames or randomly selected. The selected frame may be a frame having a mesh that optimizes a rate distortion when decimated.

The process proceeds to operation S606 where decimation is performed on the polygon mesh of the selected one frame by reusing the plurality of consecutive mesh frames which share the same decimated mesh.

The process proceeds to operation S608 where encoding of the polygon mesh in the plurality of frames is performed. For example, if the first frame is selected for decimation, the first frame is encoded in accordance with the decimated mesh. Subsequently, the polygon mesh in each remaining frame may be encoded by determining displacements between the decimated mesh and the respective polygon mesh in each remaining frame, and encoding the displacements.

The decoder 210 (FIG. 2) may receive a coded video bitstream including the encoded plurality of frames encoded by the encoder using the process illustrated in FIG. 6. The coded video bitstream may include a parameter identifying a length or number of frames in a decimation intra-refresh period. The decoder 210 may extract this parameter and the set of encoded frames corresponding the decimation intra-refresh period. The decoder 210 may decode a first frame from the set of frames having a mesh that was decimated by the encoder. The decoder 210 may decode the remaining frames using the mesh of the first frame. For example, encoded displacements between the mesh of the first frame and the meshes in the remaining frames may be used to decode the meshes in the remaining frame.

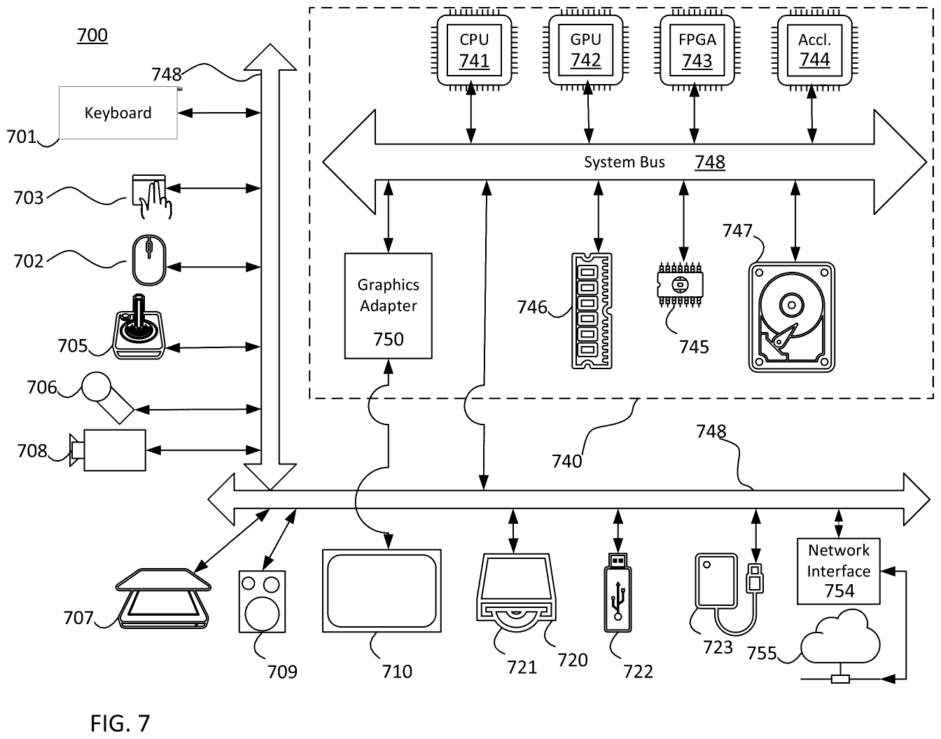

The techniques, described above, may be implemented as computer software using computer-readable instructions and physically stored in one or more computer-readable media. For example, FIG. 7 shows a computer system 700 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 7 for computer system 700 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 701, mouse 702, trackpad 703, touch screen 710, data-glove, joystick 705, microphone 706, scanner 707, and camera 708.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, data glove, or joystick 705, but there may also be tactile feedback devices that do not serve as input devices). For example, such devices may be audio output devices (such as: speakers 709, headphones (not depicted)), visual output devices (such as screens 710 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 700 may also include human accessible storage devices and their associated media such as optical media including CD/DVD ROM/RW 720 with CD/DVD or the like media 721, thumb-drive 722, removable hard drive or solid state drive 723, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 700 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 749 (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks, computer system 700 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 755. Certain protocols and protocol stacks may be used on each of those networks and network interfaces as described above.

Aforementioned human interface devices, human-accessible storage devices, and network interfaces 754 may be attached to a core 740 of the computer system 700.

The core 740 may include one or more Central Processing Units (CPU) 741, Graphics Processing Units (GPU) 742, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 may be accessible in the form of one or more physical plugs to enable extensions by additional CPUs, GPU, and the like. The peripheral devices may be attached either directly to the core's system bus 748, or through a peripheral bus 749. Architectures for a peripheral bus include PCI, USB, and the like. A graphics adapter 750 may be included in the core 740.

CPUs 741, GPUs 742, FPGAs 743, and accelerators 744 may execute certain instructions that, in combination, may make up the aforementioned computer code. That computer code may be stored in ROM 745 or RAM 746. Transitional data may be also be stored in RAM 746, whereas permanent data may be stored for example, in the internal mass storage 747. Fast storage and retrieve to any of the memory devices may be enabled through the use of cache memory, that may be closely associated with one or more CPU 741, GPU 742, mass storage 747, ROM 745, RAM 746, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 700, and specifically the core 740 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 740 that are of non-transitory nature, such as core-internal mass storage 747 or ROM 745. The software implementing various embodiments of the present disclosure may be stored in such devices and executed by core 740. A computer-readable medium may include one or more memory devices or chips, according to particular needs. The software may cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system may provide functionality as a result of logic hardwired or otherwise embodied in a circuit (for example: accelerator 744), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The above disclosed embodiments may be implemented in an image and/or video decoding process or an image and/or video encoding process. The decoding/encoding process can be used in a video decoder device. Additionally, the decoding/encoding process can also be used in a video encoder device. In some embodiments, the process is executed by processing circuitry, such as the processing circuitry that performs functions of the video decoder, the processing circuitry that performs functions of the video decoder, and the like. In other embodiments, the process is executed by processing circuitry, such as the processing circuitry that performs functions of the video encoder, the processing circuitry that performs functions of the video encoder, and the like. In some embodiments, the process is implemented in software instructions, thus when the processing circuitry executes the software instructions, the processing circuitry performs the process. In other embodiments, the process can be implemented on the chip as a hardware process, thus when the processing circuitry executes the hardware instructions, the processing circuitry performs the process. The process can be suitably adapted. Steps in the process as described above can be modified and/or omitted. Additional steps can be added. Any suitable order of implementation can be used.

The techniques described above can be implemented as computer software using computer-readable instructions and physically stored in one or more computer-readable media. For example, a computer system can be suitable for implementing certain embodiments of the disclosed subject matter. The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like. The instructions can be executed on various types of computers or components thereof, including, for example, personal computers, tablet computers, servers, smartphones, gaming devices, internet of things devices, and the like. The components for computer system are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Those skilled in the art should also understand that term “computer readable media” as used in connection with the presently disclosed subject matter does not encompass transmission media, carrier waves, or other transitory signals.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method performed by at least one processor in an encoder includes: receiving a plurality of consecutive mesh frames, each mesh frame including a polygon mesh; selecting one frame from the plurality of consecutive mesh frames; performing decimation on the polygon mesh of the one frame to generate a decimated mesh by reusing the plurality of consecutive mesh frames which share the same decimated mesh; and encoding, using the decimated mesh, the polygon mesh in at least one frame from the plurality frames excluding the one frame.

(2) The method according to feature (1), in which the one frame is the first frame in the plurality of consecutive mesh frames which chare the same decimated mesh.

(3) The method according to feature (1), in which the one frame is a center frame from the plurality of consecutive mesh frames which share the same decimated mesh.

(4) The method according to feature (1), in which the one frame is randomly selected from the plurality of consecutive mesh frames which share the same decimated mesh.

(5) The method according to feature (1), in which the one frame is selected from the plurality of frames in which the decimated mesh of the one frame optimizes a rate distortion.

(6) The method according to feature (5), in which the decimated mesh of the one frame that optimizes the rate distortion has the fewest bits for encoding.

(7) The method according to feature (5), in which the decimated mesh of the one frame that optimizes the rate distortion has a lowest distortion according to a point-to-point distance error or a point-to-plane distance error.

(8) The method according to feature (5), in which each mesh of the plurality of consecutive mesh frames has a temporal decimation cost that is a weighted sum of an encoding rate and a distortion error, in which the decimated mesh of the one frame that optimizes the rate distortion has the lowest temporal decimation cost.

(9) The method according to any one of features (1)-(8), in which the decimated mesh of the one frame includes at least one vertex in which a two-dimensional coordinate of the at least one vertex is refined based on a coordinate average of each vertex from each mesh of the plurality of frame excluding the one frame that is within a radius of the at least one vertex.

(10) The method according to any one of features (1)-(9), in which the one frame is a first frame and the decimated mesh is a first decimated mesh, the method further including: in which decimation is performed on a second frame from the plurality of frames to generate a second decimated mesh, performing a re-meshing operation on the second frame such that the second frame has a same connectivity as the first decimated mesh.

(11) The method according to any one of features (1)-(10), in which the re-meshing operation includes modifying one or more vertex positions of the second mesh to optimize a fit to the first mesh by minimizing a point-to-point error metric or a point-to-plane error metric.

(12) The method according to any one of features (1)-(11), in which the one frame is a first frame and the decimated mesh is a first decimated mesh, in which decimation is performed on a second frame from the plurality of frames to generate a second decimated mesh, in which the second frame is consecutive to the first frame, in which the first decimated mesh is encoded, and in which a residue corresponding to a difference between each vertex in the second decimated mesh and a corresponding vertex in the first mesh is encoded.

(13) A method performed by at least one processor in a decoder includes: receiving a coded video bitstream comprising a plurality of consecutive mesh frames; extracting from the coded video bitstream a parameter indicating a number of a set of frames from the plurality of consecutive mesh frames that are associated with each other; decoding a decimated mesh of a first frame from the plurality of consecutive mesh frames that share the same decimated mesh; and decoding a second frame from the set of frames using the decimated mesh of the first frame.

(14) The method according to feature (13), in which the decoding the second frame includes decoding a residual between the decimated mesh of the first frame and a decimated mesh of the second frame.

(15) The method according to feature (13), in which the decimated mesh of the first frame optimizes a rate distortion with respect to a mesh in each other frame in the set of frames.

(16) The method according to feature (15), in which the decimated mesh of the first frame that optimizes the rate distortion has the fewest bits for encoding.

(17) The method according to feature (15), in which the decimated mesh of the first frame that optimizes the rate distortion has a lowest distortion according to a point-to-point distance error or a point-to-plane distance error.

A method performed by at least one processor in an encoder includes processing a plurality of consecutive mesh frames, each mesh frame including a polygon mesh; in which one frame from the plurality of consecutive mesh frames is selected, wherein decimation is performed on the polygon mesh of the one frame to generate a decimated mesh by reusing the plurality of consecutive mesh frames which share the same decimated mesh, and in which the polygon mesh in at least one frame from the plurality frames excluding the one frame is encoded using the decimated mesh.

(19) The method according to feature (18), in which the one frame is the first frame in the plurality of frames.

(20) The method according to feature (18), in which the one frame is a center frame from the plurality of frames.

What is claimed is:

1. A method performed by at least one processor in an encoder, the method comprising:
receiving a plurality of consecutive mesh frames, each mesh frame including a polygon mesh;
selecting one frame from the plurality of consecutive mesh frames;
performing decimation on the polygon mesh of the one frame to generate a decimated mesh by reusing the plurality of consecutive mesh frames which share the same decimated mesh; and
encoding, using the decimated mesh, the polygon mesh in at least one frame from the plurality frames excluding the one frame.

2. The method according to claim 1, wherein the one frame is the first frame in the plurality of consecutive mesh frames which share the same decimated mesh.

3. The method according to claim 1, wherein the one frame is a center frame from the plurality of consecutive mesh frames which share the same decimated mesh.

4. The method according to claim 1, wherein the one frame is randomly selected from the plurality of consecutive mesh frames which share the same decimated mesh.

5. The method according to claim 1, wherein the one frame is selected from the plurality of frames in which the decimated mesh of the one frame optimizes a rate distortion.

6. The method according to claim 5, wherein the decimated mesh of the one frame that optimizes the rate distortion has the fewest bits for encoding.

7. The method according to claim 5, wherein the decimated mesh of the one frame that optimizes the rate distortion has a lowest distortion according to a point-to-point distance error or a point-to-plane distance error.

8. The method according to claim 5, wherein each mesh in the plurality of consecutive mesh frames has a temporal decimation cost that is a weighted sum of an encoding rate and a distortion error, wherein the decimated mesh of the one frame that optimizes the rate distortion has the lowest temporal decimation cost.

9. The method according to claim 1, wherein the decimated mesh of the one frame includes at least one vertex in which a two-dimensional coordinate of the at least one vertex is refined based on a coordinate average of each vertex from each mesh of the plurality of frame excluding the one frame that is within a radius of the at least one vertex.

10. The method according to claim 1, wherein the one frame is a first frame and the decimated mesh is a first decimated mesh, the method further comprising:
wherein decimation is performed on a second frame from the plurality of frames to generate a second decimated mesh,
performing a re-meshing operation on the second frame such that the second frame has a same connectivity as the first decimated mesh.

11. The method according to claim 10, wherein the re-meshing operation includes modifying one or more vertex positions of the second mesh to optimize a fit to the first mesh by minimizing a point-to-point error metric or a point-to-plane error metric.

12. The method according to claim 1, wherein the one frame is a first frame and the decimated mesh is a first decimated mesh,
wherein decimation is performed on a second frame from the plurality of frames to generate a second decimated mesh,
wherein the second frame is consecutive to the first frame,
wherein the first decimated mesh is encoded, and
wherein a residue corresponding to a difference between each vertex in the second decimated mesh and a corresponding vertex in the first mesh is encoded.

13. A method performed by at least one processor in a decoder, the method comprising:
receiving a coded video bitstream comprising a plurality of consecutive mesh frames;
extracting from the coded video bitstream a parameter indicating a number of a set of frames from the plurality of consecutive mesh frames that are associated with each other;
decoding a decimated mesh of a first frame from the plurality of consecutive mesh frames that share the same decimated mesh; and
decoding a second frame from the set of frames using the decimated mesh of the first frame.

14. The method according to claim 13, wherein the decoding the second frame includes decoding a residual between the decimated mesh of the first frame and a decimated mesh of the second frame.

15. The method according to claim 13, wherein the decimated mesh of the first frame optimizes a rate distortion with respect to a mesh in each other frame in the set of frames.

16. The method according to claim 15, wherein the decimated mesh of the first frame that optimizes the rate distortion has the fewest bits for encoding.

17. The method according to claim 15, wherein the decimated mesh of the first frame that optimizes the rate distortion has a lowest distortion according to a point-to-point distance error or a point-to-plane distance error.

18. A method performed by at least one processor in an encoder, the method comprising:
processing a plurality of consecutive mesh frames, each mesh frame including a polygon mesh;
wherein one frame from the plurality of consecutive mesh frames is selected,
wherein decimation is performed on the polygon mesh of the one frame to generate a decimated mesh by reusing the plurality of consecutive mesh frames which share the same decimated mesh, and
wherein the polygon mesh in at least one frame from the plurality frames excluding the one frame is encoded using the decimated mesh.

19. The method according to claim 18, wherein the one frame is the first frame in the plurality of frames.

20. The method according to claim 18, wherein the one frame is a center frame from the plurality of frames.
